(19) United States
(12) Patent Application Publication
(10) Pub. No.: US 2025/0378321 A1
(43) Pub. Date: Dec. 11, 2025

(54) EXTREMAL EIGENSTATE DETERMINATION SYSTEM

(71) Applicant: NORTHROP GRUMMAN SYSTEMS CORPORATION, FALLS CHURCH, VA (US)

(72) Inventors: PHILLIP LAURENCE HELMS, Centennial, CO (US); MATTHEW E. WEIPPERT, Franktown, CO (US); RYAN J. EPSTEIN, Denver, CO (US)

(21) Appl. No.: 18/738,672

(22) Filed: Jun. 10, 2024

(51) Int. Cl. G06N 3/08; G06N 3/04

(52) U.S. Cl. CPC G06N 3/08; G06N 3/04

(57) ABSTRACT

One example includes a hybrid eigenstate determination algorithm. The hybrid eigenstate determination algorithm includes a limited multistate optimization algorithm configured to determine a state set comprising estimated extremal eigenstates of a bundled tree tensor network state (TTNS) based on predefined algorithm parameters. The bundled TTNS can be associated with a quantity of extremal eigenstates of a tree tensor network operator (TTNO) to be determined. The hybrid eigenstate determination algorithm also includes a single-state optimization algorithm configured to select at least one estimated extremal eigenstate of the determined state set and to sequentially optimize the selected at least one estimated extremal eigenstate of the state set to convergence to determine a respective at least one of the extremal eigenstates of the TTNO.

### GOVERNMENT INTEREST

The invention was made under Government Contract. Therefore, the U.S. Government has rights to the invention as specified in that contract.

### TECHNICAL FIELD

The present invention relates generally to computer systems, and specifically to an extremal eigenstate determination system.

### BACKGROUND

To provide modeling of the data represented by a matrix, it is often useful to determine the eigenstates of the matrix, corresponding to the extremal eigenvalues. To determine the extremal eigenstates of the matrix, algorithms can be implemented based on performing eigenproblem calculations on a tensor network representation of the matrix. The tensor network matrix, or tensor network operator (TNO) consists of tensors that are each associated with subsystems of the vector space on which the matrix is defined. Some algorithms can operate rapidly to determine some extremal (e.g., low-lying) eigenstates but can omit states if the random initial states are close to other eigenstates of the tensor network matrix. Other algorithms might be able to determine a large set of extreme eigenstates of the tensor network matrix without omitting states, but can be computationally expensive and can take an impractically long time to determine such eigenstates.

### SUMMARY

One example includes a hybrid eigenstate determination algorithm. The hybrid eigenstate determination algorithm includes a limited multistate optimization algorithm configured to determine a state set comprising estimated extremal eigenstates of a bundled tree tensor network state (TTNS) based on predefined algorithm parameters. The bundled TTNS can be associated with a quantity of extremal eigenstates of a tree tensor network operator (TTNO) to be determined. The hybrid eigenstate determination algorithm also includes a single-state optimization algorithm configured to select at least one estimated extremal eigenstate of the determined state set and to sequentially optimize the selected at least one estimated extremal eigenstate of the state set to convergence to determine a respective at least one of the extremal eigenstates of the TTNO.

Another example includes a method for determining a plurality of extremal eigenstates of a TTNO. The method includes defining algorithm parameters comprising an optimized state quantity defining a size of a state index for each of a plurality of TTNSs associated with the TTNO, the size being associated with a quantity of extremal eigenstates that is a proper subset of the extremal eigenstates of the TTNO. The method also includes implementing a hybrid eigenstate determination algorithm comprising a plurality of iterations. Implementing the hybrid eigenstate determination algorithm includes implementing a limited multistate optimization algorithm in a first iteration to sequentially shift the state index and orthogonality center to each tensor of a first one of the bundled TTNSs to determine a first state set comprising first estimated extremal eigenstates having the quantity of extremal eigenstates defined by the optimized state quantity, and implementing a single-state optimization algorithm in the first iteration to select at least one of the first estimated extremal eigenstates of the determined first state set and to sequentially optimize the selected at least one of the first estimated extremal eigenstates of the first state set to convergence to determine a respective first converged set of at least one converged extremal eigenstate of the TTNO. Implementing the hybrid eigenstate determination algorithm also includes implementing the limited multistate optimization algorithm in a second iteration to sequentially shift the state index and the orthogonality center to each tensor in a second one of the bundled TTNSs to determine a second state set comprising second estimated extremal eigenstates having the quantity of extremal eigenstates defined by the optimized state quantity, and implementing the single-state optimization algorithm in the second iteration to select at least one of the second estimated extremal eigenstates of the determined second state set and to sequentially optimize the selected at least one of the second estimated extremal eigenstates of the second state set to convergence to determine a respective second converged set of at least one extremal eigenstate of the TTNO.

Another example includes a non-transitory computer readable medium comprising machine-readable instructions. The machine-readable instructions can be executed to implement a hybrid eigenstate determination algorithm in each of a plurality of iterations. The hybrid eigenstate determination algorithm can be configured to generate a TTNS associated with extremal eigenstates of a TTNO in each of the iterations. The hybrid eigenstate determination algorithm can also be configured to implement a limited multistate optimization algorithm configured to determine a state set in each of the iterations, the state set being different in each of the iterations and comprising estimated extremal eigenstates of a bundled TTNS based on predefined algorithm parameters. The hybrid eigenstate determination algorithm can further be configured to implement a single-state optimization algorithm configured to select at least one estimated extremal eigenstate of the determined state set associated with the respective one of the iterations and to sequentially optimize the selected at least one estimated extremal eigenstate of the state set associated with the respective one of the iterations to convergence to determine a respective at least one of the extremal eigenstates of the bundled TTNS in each of the iterations to determine the extremal eigenstates of the TTNO.

### BRIEF DESCRIPTION OF THE DRAWINGS

FIG. 1 illustrates an example of an extremal eigenstate determination system.

FIG. 2 illustrates another example of an extremal eigenstate determination system.

FIG. 3 illustrates an example diagram of algorithm parameters stored in a memory.

FIG. 4 illustrates an example diagram of a hybrid eigenstate determination algorithm.

FIG. 5 illustrates an example diagram of determining extremal eigenstates.

FIG. 6 illustrates an example of a method for determining extremal eigenstates of a tree tensor network operator.

### DETAILED DESCRIPTION

The present invention relates generally to computer systems, and specifically to an extremal eigenstate determination system. The extremal eigenstate determination system can be implemented on a computer system that includes a processing unit and a memory. The processing unit can be configured to implement algorithms to determine a desired set of extremal eigenstates (i.e. the eigenstates associated with the lowest or highest eigenvalue) of a Hermitian or real symmetric matrix which can be approximated by a loop-free tensor network, also known as a tree tensor network operator (TTNO) As described herein, the term “loop-free tensor network representation” refers to vectors or matrices approximately represented as any of a variety of loop-free tensor networks, such as a matrix product state (MPS), matrix product operator (MPO), or any of a variety of other types of non-looped tensor network vector or matrix representations. As described hereinafter, the term “tree tensor network operator” or “TTNO” is used in place of “loop-free tensor network matrix operator” for brevity, and refers to any of the above examples of loop-free tensor network matrix representations.

As described herein, the determination of a desired set of extremal eigenstates can result from implementation of a hybrid eigenstate determination algorithm to solve eigenvector problems where a given matrix/operator and/or vector/state can be approximated by tree tensor network operators (e.g., MPOs) and tree tensor network states (e.g., MPSs). Therefore, the hybrid eigenstate determination algorithm can be applicable, as described herein, to any eigenstate problem where the eigenstate(s) can be approximately represented by tree tensor network states and the operator(s) can be approximated by a compatible tree tensor network operator.

The extremal eigenstate determination system can be implemented to find the extremal eigenstates in any of a variety of applications. As one example, the extremal eigenstate determination system can be applied to any of a variety of quantum systems, such as superconducting circuits, qubits, quantum chemistry simulations, conformal field theory, and/or disordered systems. As another example, the extremal eigenstate determination system can be implemented in any of a variety of classical systems, such as chemical reaction networks, traffic modeling and optimization control, glassy dynamics, and/or computational fluid dynamics. The extremal eigenstate determination system can be used in other examples, as well, such as artificial intelligence and/or machine learning applications. Accordingly, the extremal eigenstate determination system can be implemented for a variety of purposes as described herein.

The extremal eigenstate determination system can include a hybrid eigenstate determination algorithm that can be executed by the processing unit. The hybrid eigenstate determination algorithm can be configured to operate in a plurality of iterations of implementing a limited multistate optimization algorithm, with respect to bundled tree tensor network states, followed by a single-state optimization algorithm, with respect to a (non-bundled) tree tensor network state (TTNS). For example, the bundled TTNS can be generated based on bundling a quantity of non-bundled tree tensor network states that is sought to be optimized by the extremal eigenstate determination system. For example, the bundled tensor network states can be generated by providing decomposition of a set of vectors into individual TTNS tensors (e.g., MPS tensors) each having a physical index associated with a subsystem of the Hilbert space. The TTNS tensors can be interconnected by a virtual bond, the dimension of which can dictate the size of each of the TTNS tensors. The hybrid eigenstate determination algorithm can thus be configured to optimize extremal eigenstates associated with the tree tensor network operator by performing a plurality of sweeps across the bundled tree tensor network states via the multistate optimization algorithm and non-bundled tree tensor network states via the single-state optimization algorithm in sequence at each iteration of the hybrid eigenstate determination algorithm.

As an example, the limited multistate optimization algorithm can correspond to a modified implementation of any of a variety of multistate optimization algorithms that are configured to concurrently optimize many extremal eigenstates associated with a TTNO while minimizing the skipping of any orthogonal eigenstates in an ascending or descending eigenvalue sequence. However, as described herein, the limited multistate optimization algorithm can be implemented to optimize a quantity of estimated extremal eigenstates in a bundled TTNS that is a proper subset of the desired number of total extremal eigenstates associated with the TTNO. For example, the limited multistate optimization algorithm can be configured to determine a state set of different estimated extremal eigenstates in each of the iterations based on orthogonality constraints. The orthogonality constraints can correspond to previously determined extremal eigenstates, thereby allowing for the next most extremal eigenstates to be determined in the next iteration of the hybrid eigenstate determination algorithm (e.g., including both the limited multistate optimization algorithm and the single-state optimization algorithm).

The operation of the limited multistate optimization algorithm can also be subject to algorithm parameters (e.g., programmed by a user). As an example, the algorithm parameters can dictate a sweep convergence tolerance, such that the estimated extremal eigenstates of the state set in the bundled TTNS can be optimized by the limited multistate optimization algorithm across a series of sweeps in a given iteration until the estimated extremal eigenvalues or eigenstates achieve a predefined convergence. As another example, the algorithm parameters can dictate a predefined quantity of sweeps, such that the limited multistate optimization algorithm concludes optimization upon providing the predefined quantity of sweeps. For example, the convergence can be dictated by a maximum bond dimension, such that the limited multistate optimization algorithm concludes optimization after the bond dimension exceeds this predefined value. As another example, the algorithms parameters can dictate an eigenstate or eigenvalues accuracy estimated by comparing with the immediate previously optimized bond dimension. Such algorithm parameters described above can thus define limits for the convergence of the estimated extremal eigenstates of the state set.

Another algorithm parameter can be an optimized state quantity that defines a quantity of estimated extremal eigenstates stored in the bundled TTNS and optimized by the limited multistate optimization algorithm in a given iteration of the hybrid eigenstate determination algorithm. The optimized state quantity also controls the size of the state index which can be sequentially shifted along with the orthogonality center (e.g., canonical center) of the bundled TTNS to each of the tensors during the sweep to calculate a small eigenproblem for the quantity of estimated extremal eigenstates defined by the optimized state quantity as a proper subset of the quantity of total desired extremal eigenstates associated with the TTNO. In this manner, selecting the algorithm parameters to define the quantity of eigenstates to be optimized in the state set and to define the optimization limits of the eigenstates in the state set can minimize run-time while mitigating skipped eigenstates to provide sufficiently accurate initial eigenstates for subsequent single-state optimization, as described in greater detail herein.

In each given iteration, the hybrid eigenstate determination algorithm can switch from the limited multistate optimization algorithm to the single-state optimization algorithm to provide convergence of at least one of the estimated extremal eigenstates determined by the limited multistate optimization algorithm. As an example, the single-state optimization algorithm can correspond to any of a variety of types of algorithms that are configured to rapidly optimize a single eigenstate to convergence. For example, in response to each of the estimated extremal eigenstates achieving an optimization limit defined by one or more of the algorithm parameters, the hybrid eigenstate determination algorithm can switch from the limited multistate optimization algorithm to the single-state optimization algorithm. The single-state optimization algorithm can be configured to select at least one of the most extreme of the estimated extremal eigenstates and to optimize the respective at least one of the most extreme of the estimated extremal eigenstates to convergence as a first converged set of at least one converged extremal eigenstate of the TTNO, such as based on another one of the algorithm parameters.

The converged extremal eigenstates from the single-state optimization algorithm can thus correspond to at least one of the estimated extremal eigenstates converged in the limited multistate optimization algorithm, with the estimated extremal eigenstates converged in the limited multistate optimization algorithm corresponding to the total extremal eigenstates of the TTNO. The converged extremal eigenstate(s) determined by the single-state optimization algorithm can thus be provided as orthogonality constraints to the limited multistate optimization algorithm in the next iteration. Therefore, in the next iteration, the limited multistate optimization algorithm can determine the next state set that includes estimated eigenstates having a next higher eigenvalue (for optimizing the lowest estimated eigenstates) or lower eigenvalue (for optimizing the highest estimated eigenstates) relative to the converged extremal eigenstate(s) determined by the single-state optimization algorithm in previous iterations of the hybrid eigenstate determination algorithm. The process thus repeats in each iteration of the hybrid eigenstate determination algorithm until the desired number of eigenstates of the TTNO, are determined. By implementing the hybrid eigenstate determination algorithm as including both the limited multistate optimization algorithm and the single-state optimization algorithm in each iteration, the desired number of extremal eigenstates of the TTNO can thus be determined rapidly and in ascending or descending order while minimizing the skipping of any of the extremal eigenstates.

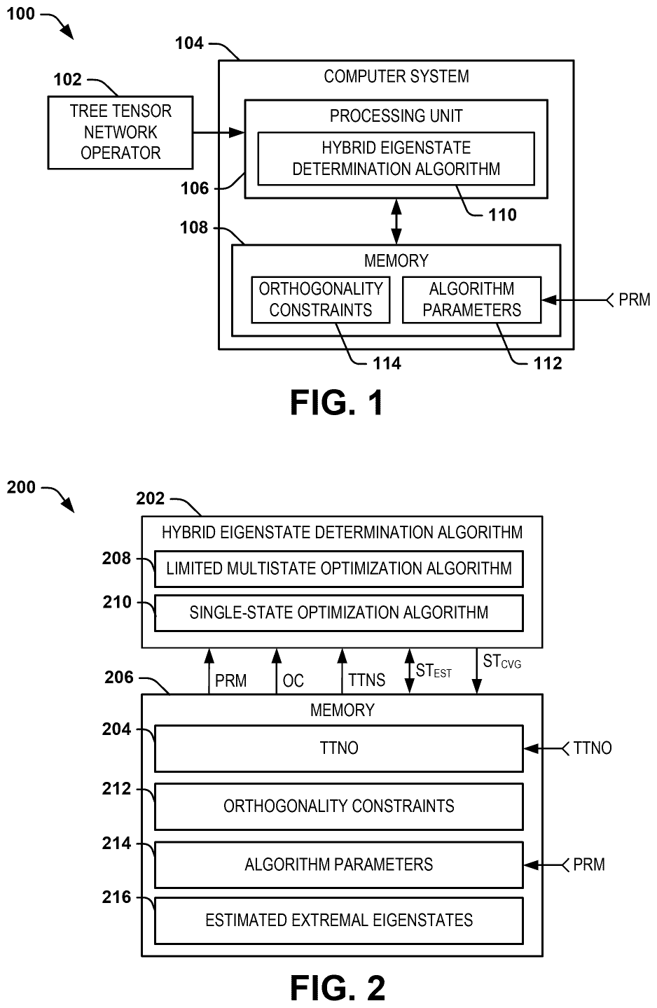

FIG. 1 illustrates an example of an extremal eigenstate determination system 100. The extremal eigenstate determination system 100 can be applied to a computing system to determine the set of extremal eigenstates of a tree tensor network operator (TTNO) 102. The diagram of the extremal eigenstate determination system 100 in the example of FIG. 1 is demonstrated by functional blocks that can each correspond diagrammatically to software, hardware, a combination of software and hardware, and/or collections of data, as described herein. As an example, the TTNO 102 can correspond to any of a variety of Hermitian matrices.

In the example of FIG. 1, the extremal eigenstate determination system 100 includes a computer system 104 that includes a processing unit 106 and a memory 108. The processing unit 106 is demonstrated as including a hybrid eigenstate determination algorithm 110 that is configured to determine a desired set of extremal eigenstates of the TTNO 102. The hybrid eigenstate determination algorithm 110 can be configured to operate in a plurality of iterations of implementing both a limited multistate optimization algorithm and a single-state optimization algorithm in a sequence. The hybrid eigenstate determination algorithm 110 can operate the limited multistate optimization algorithm on at least one bundled tree tensor network state (TTNS) that is generated for the TTNO 102 in each iteration of the hybrid eigenstate determination algorithm 110, and can operate the single-state optimization algorithm on a tensor network representation of the eigenstates associated with one or more estimated extremal eigenstates determined by the limited multistate optimization algorithm.

For example, the bundled TTNS can be generated in each iteration based on bundling a quantity of (non-bundled) tree tensor network states that is sought to be optimized by the limited multistate optimization algorithm in each iteration of the hybrid eigenstate determination system 100. For example, the bundled TTNS can be generated in a variety of different ways, such as based on including random entries in each individual bundled TTNS tensor (hereinafter “tensor”) subject to orthogonality constraints of previously determined eigenstates. For example, the bundled TTNS can be generated by providing decomposition of a state, vector, or tensor into individual bundled TTNS tensors, each being associated with nodes of the TTNO 102 having a physical index that indexes a basis for each subsystem vector space of the respective node. The tensors can be interconnected by a virtual bond, the bond dimension of which can dictate the size of each of the tensors. The hybrid eigenstate determination algorithm 110 can thus be configured to optimize arbitrary eigenstates associated with the bundled TTNS by performing a plurality of sweeps across the bundled TTNS via the limited multistate optimization algorithm in sequence at each iteration of the hybrid eigenstate determination algorithm 110 to determine the estimated extremal eigenstates.

As an example, the limited multistate optimization algorithm can correspond to any of a variety of types of algorithms that are configured to optimize multiple extremal eigenstates concurrently while minimizing the skipping of any orthogonal eigenstates in an ascending or descending eigenvalue sequence. For example, the limited multistate optimization algorithm can correspond to a modified multistate optimization algorithm, such as a bundled MPS convergence algorithm using a block Lanczos algorithm, a state averaging-based convergence algorithm using a Davidson diagonalization algorithm, or any of a variety of other multistate tensor network algorithms using any variety of associated techniques such as block Lanczos or state-averaging. However, as opposed to conventional multistate algorithms, as described in greater detail herein, the limited multistate optimization algorithm can be implemented to optimize a quantity of estimated extremal eigenstates that is a proper subset of the total desired extremal eigenstates associated with the TTNO 102. For example, the limited multistate optimization algorithm can be configured to determine a different state set of estimated extremal eigenstates in each of the iterations based on predefined algorithm parameters 112 and orthogonality constraints 114 stored in the memory 108 to decrease a run-time of the limited multistate optimization algorithm. In the example of FIG. 1, the algorithm parameters 112 can be programmable and provided via inputs to the computer system 104, demonstrated as a signal PRM. The operation of the limited multistate optimization algorithm, subject to the algorithm parameters 112 and the orthogonality constraints 114, can provide the state set as including the estimates for a proper subset of extremal eigenstates of the TTNO 102, at least a portion of which are to be optimized further in the present iteration of the hybrid eigenstate determination algorithm 110.

As defined herein, the term “optimize” (and forms thereof) refers to minimizing or maximizing the Rayleigh quotient associated with the operator defined by the TTNO. As also defined herein, the term “converge” (and forms thereof) refers to the settling of a given eigenstate or corresponding eigenvalue such that subsequent optimization change results by an amount less than a specified tolerance.

As an example, the algorithm parameters 112 can include optimized state quantity that defines a quantity of estimated extremal eigenstates determined by the limited multistate optimization algorithm in a given iteration of the hybrid eigenstate determination algorithm 110. The optimized state quantity can also determine a size of a state index that can be sequentially shifted to each of the tensors, along with an orthogonality center tensor, during an optimization sweep to provide an eigenproblem calculation for the quantity of estimated extremal eigenstates defined by the optimized state quantity, as a proper subset of the desired number of extremal eigenstates associated with the TTNO. Additionally, the algorithm parameters 112 can include limit parameters. As described herein, the term “limit parameter” refers to a parameter used in the limited multistate optimization algorithm that can reduce the computational cost and accuracy of the limited multistate optimization algorithm relative to a typical (e.g., full) multistate optimization algorithm.

The limit parameters can include a maximum bond dimension or reduction in eigenstate or eigenvalue accuracy relative to the desired accuracy, and/or can include a maximum number of sweeps for the limited multistate optimization algorithm or a reduction in a sweep convergence tolerance. Based on the optimization of the defined quantity of estimated extremal eigenstates as a proper subset of the desired number of extremal eigenstates of the TTNO, and based on the defined maximum bond dimension and/or the defined maximum number of sweeps, the limited multistate optimization algorithm can provide a more rapid estimation of the state set of estimated extremal eigenstates. Therefore, the single-state optimization algorithm can select one or more of the estimated extremal eigenstates of the state set to provide rapid convergence of the selected estimated extremal eigenstate(s) of the state set in a given iteration of the hybrid eigenstate determination algorithm 110.

In each given iteration, the hybrid eigenstate determination algorithm 110 can switch from the limited multistate optimization algorithm to the single-state optimization algorithm to provide convergence of at least one of the estimated extremal eigenstates determined by the limited multistate optimization algorithm. As an example, the single-state optimization algorithm can correspond to any of a variety of types of algorithms that are configured to rapidly optimize a single eigenstate to convergence. For example, the single-state optimization algorithm can be an algorithm that determines a single eigenstate based on the orthogonality constraints 114 corresponding to the extremal eigenstates that were previously determined by the hybrid eigenstate determination algorithm 110. The single-state optimization algorithm can be configured to select at least one of the most extreme (e.g., lowest or highest) of the estimated extremal eigenstates in the state set and to optimize the respective at least one of the most extreme of the estimated extremal eigenstates to convergence as a converged set of at least one converged extreme eigenstate of the TTNO.

The converged most extreme eigenstates in each iteration can thus correspond to a proper subset of the total extremal eigenstates of TTNO (e.g., the highest or lowest of the respective highest or lowest eigenstates of the TTNO). The converged most extreme eigenstate(s) determined by the single-state optimization algorithm can be stored in the memory 108 as the orthogonality constraints 114 for the next iterations of the hybrid eigenstate determination algorithm 110. Therefore, in the next iteration, the limited multistate optimization algorithm can determine the next state set that includes estimated eigenstates having a next higher or lower eigenvalue relative to the converged most extreme eigenstate(s) determined by the single-state optimization algorithm in the previous iteration. The hybrid eigenstate determination algorithm can repeat the iterative process in each iteration until the desired total extremal eigenstates of the TTNO 102 are determined. Therefore, by implementing the hybrid eigenstate determination algorithm 110 as including both the limited multistate optimization algorithm and the single-state optimization algorithm in each iteration, the extremal eigenstates of the TTNO can be determined rapidly and in ascending order (for determining lowest eigenstates) or descending order (for determining highest eigenstates) while minimizing the skipping of any of the extremal eigenstates.

FIG. 2 illustrates another example of an extremal eigenstate determination system 200. The extremal eigenstate determination system 200 can correspond to portions of the extremal eigenstate determination system 100 in the example of FIG. 1. Therefore, reference is to be made to the example of FIG. 1 in the following description of the example of FIG. 2.

The extremal eigenstate determination system 200 includes a hybrid eigenstate determination algorithm 202 that is configured to determine a desired set of extremal eigenstates of a TTNO 204. In the example of FIG. 2, the TTNO 204 is demonstrated as being provided as an input “TTNO” to a memory 206, such that the TTNO input is stored in the memory as the TTNO 204. As described above in the example of FIG. 1, the hybrid eigenstate determination algorithm 202 can be configured to operate in a plurality of iterations of implementing both a limited multistate optimization algorithm 208 and a single-state optimization algorithm 210 in a sequence.

The hybrid eigenstate determination algorithm 202 can operate the limited multistate optimization algorithm 208 on a bundled TTNS generated for each respective iteration, and can operate the single-state optimization algorithm 210 on a tensor network representation of the eigenstate(s) (hereinafter “tree tensor network state(s)”) associated with one or more estimated extremal eigenstates determined by the limited multistate optimization algorithm 208. For example, the bundled TTNS can be generated from the TTNO 204 in each iteration of the hybrid eigenstate determination algorithm 202, such as via the processing unit 106. For example, the bundled TTNS can be generated in each iteration based on bundling a quantity of extremal eigenstates that is sought to be determined by in each iteration the extremal eigenstate determination system 200. The bundled TTNS is demonstrated as being provided from the memory 206 as an input to the hybrid eigenstate determination algorithm 202.

The hybrid eigenstate determination algorithm 202 can operate the limited multistate optimization algorithm 208 on the bundled TTNS generated for the respective iteration, and can operate the single-state optimization algorithm 210 on a tensor network representation of the eigenstate(s) (hereinafter “tree tensor network state(s)”) associated with one or more estimated extremal eigenstates determined by the limited multistate optimization algorithm 208. The hybrid eigenstate determination algorithm 202 can thus be configured to optimize the extremal eigenstates associated with the TTNO 204 by performing a plurality of sweeps across the respective bundled TTNS via the limited multistate optimization algorithm 208 and across non-bundled TTNS(s) via the single-state optimization algorithm 210 in sequence at each iteration of the hybrid eigenstate determination algorithm 202. Therefore, as described above, the hybrid eigenstate determination algorithm 202 can achieve convergence of the desired quantity of extremal eigenstates of the TTNO 204. Implementation of each of the limited multistate optimization algorithm 208 and the single-state optimization algorithm 210 is provided by sweeping across the tensors in a sequence and performing eigenproblem calculations for each tensor. The eigensolver that is implemented (e.g., via the processing unit 106) for calculating the eigenproblem at each tensor can be any of a variety of software or hardware eigenproblem resolvers.

As described above in the example of FIG. 1, the limited multistate optimization algorithm 208 can be implemented to optimize a quantity of estimated extremal eigenstates that is a proper subset of the total number of desired extremal eigenstates associated with the TTNO 204 in each iteration. For example, the limited multistate optimization algorithm 208 can be configured to determine a different state set of estimated extremal eigenstates in each of the iterations of the hybrid eigenstate determination algorithm 202 based on orthogonality constraints 212 and algorithm parameters 214 stored in the memory 206. Similar to as described above in the example of FIG. 1, the algorithm parameters 214 can be programmable and provided via inputs to the computer system 104 and stored in the memory 206, demonstrated as a signal PRM. The operation of limited multistate optimization algorithm 208, subject to the orthogonality constraints 212 and algorithm parameters 214 provided from the memory 206 as signals OC and PRM, respectively, can provide a different state set of estimates of extremal eigenstates in each iteration of the hybrid eigenstate determination algorithm 202. As described in greater detail herein, the algorithm parameters 214 can include parameters which limit the computational cost of the limited multistate optimization algorithm 208, such as an optimized state quantity corresponding to a quantity of states in the bundled TTNS in a given iteration, as well as a maximum bond dimension, and/or maximum number of iterative optimization sweeps. A state index that is shifted along the tensors of the bundled TTNS can have a size that is determined by the quantity of estimated extremal eigenstates defined by the optimized state quantity in the limited multistate optimization algorithm 208 in a given iteration of the hybrid eigenstate determination algorithm 202. The limit parameters can define predetermined limit(s) of convergence of the estimated extremal eigenstates of the state set, thus providing a handover mechanism of the hybrid eigenstate determination algorithm 202 to switch from the limited multistate optimization algorithm 208 to the single-state optimization algorithm 210.

The estimated extremal eigenstates that are determined by the limited multistate optimization algorithm 208 in each iteration of the hybrid eigenstate determination algorithm 202 are saved to the memory 206, demonstrated as a signal ST_{EST} and in the memory 206 as estimated extremal eigenstates 218. The estimated extremal eigenstates 218 can be saved to provide redundancy for the determination of the estimated extremal eigenstates by the limited multistate optimization algorithm 208 and for the converged extremal eigenstates by the single-state optimization algorithm 210, as described in greater detail herein.

As described above, the hybrid eigenstate determination algorithm 202 can switch from the limited multistate optimization algorithm 208 to the single-state optimization algorithm 210 in each iteration, such as based on the algorithm parameters 214. Thus, the single-state optimization algorithm 210 can provide convergence of at least one of the estimated extremal eigenstates determined by the limited multistate optimization algorithm 208 to sufficient accuracy in each iteration (hereinafter described as “convergence”). The single-state optimization algorithm 210 can be configured to select at least one eigenstate (e.g., defined by the algorithm parameters 214) of the estimated extremal eigenstates of the state set determined by the limited multistate optimization algorithm 208 in the respective iteration of the hybrid eigenstate determination algorithm 202. The selected at least one eigenstate is thus initialized with a portion of the data from each tensor for further optimization.

The single-state optimization algorithm can thus optimize the respective at least one selected eigenstate to convergence. For example, the processing unit 106 can be configured to generate a tensor network state (non-bundled) associated with each of the eigenstate(s) selected from the given state set of the estimated extremal eigenstates by the single-state optimization algorithm 210 in the given iteration, and can further optimize the respective selected eigenstate(s) to convergence by sweeping across and calculating the eigenproblem at each (non-bundled) tensor of the tensor network state(s). The converged extremal eigenstates provided by the single-state optimization algorithm 210 can thus correspond to the next highest or lowest of the extremal eigenstates of the TTNO 204 determined by the hybrid eigenstate determination algorithm 202 in each iteration. The converged extremal eigenstates of the bundled TTNS determined by the single-state optimization algorithm 210 are saved in the memory 206, demonstrated as a signal ST_{CVG} and in the memory 206 as the orthogonality constraints 212.

As an example, the single-state optimization algorithm 210 can determine redundancy of eigenvalues of the determined eigenstates of the present iteration relative to a preceding iteration (e.g., the immediately preceding iteration) to select at least one of the determined eigenstates of the present iteration to initiate further optimization. For example, the single-state optimization algorithm 210 can compare the eigenvalues of the estimated extremal eigenstates determined by the limited multistate optimization algorithm 208 in a given iteration with the eigenvalues of the saved estimated extremal eigenstates 218 determined by the limited multistate optimization algorithm 208 in an immediately preceding iteration. As an example, the single-state optimization algorithm 210 can determine if the eigenvalue of a given one of the determined estimated eigenstates of the present iteration is both redundant with respect to an eigenvalue of one of the determined estimated eigenstates in a previous iteration and is a next most extremal eigenstate relative to the last eigenstate that was converged by the single-state optimization algorithm 210 in the previous iteration. If such a condition is met, the single-state optimization algorithm 210 selects the respective eigenstate of the determined eigenstates of the present iteration for further optimization. However, if the condition is not met, such that the eigenvalue of the next most extremal eigenstate relative to the last converged eigenstate in the previous iteration is not redundant or not present in the determined eigenstates of the present iteration, then the single-state optimization algorithm 210 can select one of the saved estimated extremal eigenstates 218 from the preceding iteration for convergence instead of one of the extremal eigenstates determined by the limited multistate optimization algorithm 208 in the present iteration. Therefore, the possibility of state-skipping by the single-state optimization algorithm 210 can be mitigated. Therefore, by saving the estimated extremal eigenstates 218, the hybrid eigenstate determination algorithm 202 can provide a more robust determination of the extremal eigenstates of the TTNO 204.

As described above, the converged extremal eigenstate(s) ST_{CVG} determined by the single-state optimization algorithm 210 are stored in the memory 206 as the orthogonality constraints 212. In the next iteration of the hybrid eigenstate determination algorithm 202, the limited multistate optimization algorithm 208 can access the orthogonality constraints 212 from the memory 206, demonstrated by the signal OC, and can determine the next state set of estimated extremal eigenstates based on the orthogonality constraints 212. Thus, the orthogonality constraints 212 can be provided to the limited multistate optimization algorithm 208 in the next iteration, thereby preventing the limited multistate optimization algorithm 208 from re-optimizing the eigenstates that were previously converged by the single-state optimization algorithm 210. Therefore, in the next iteration, the limited multistate optimization algorithm 208 can determine the next state set that includes estimated extremal eigenstates having a next higher eigenvalue relative to the orthogonality constraints 212, as determined by the single-state optimization algorithm 210 in the previous iterations. Additionally, as described above, the single-state optimization algorithm 210 can access the estimated extremal eigenstates 218 to ensure that the next selected estimated extremal eigenstate(s) for convergence are the next highest or lowest eigenvalue relative to the orthogonality constraints 212, thereby mitigating state-skipping.

The hybrid eigenstate determination algorithm 202 can repeat the iterative process in each iteration until the total desired extremal eigenstates of the TTNO 204 are determined. Therefore, by implementing the hybrid eigenstate determination algorithm 202 as including both the limited multistate optimization algorithm 208 and the single-state optimization algorithm 210 in each iteration, the extremal eigenstates of the TTNO 204 can be determined rapidly and in ascending or descending order while minimizing the skipping of any of the extremal eigenstates.

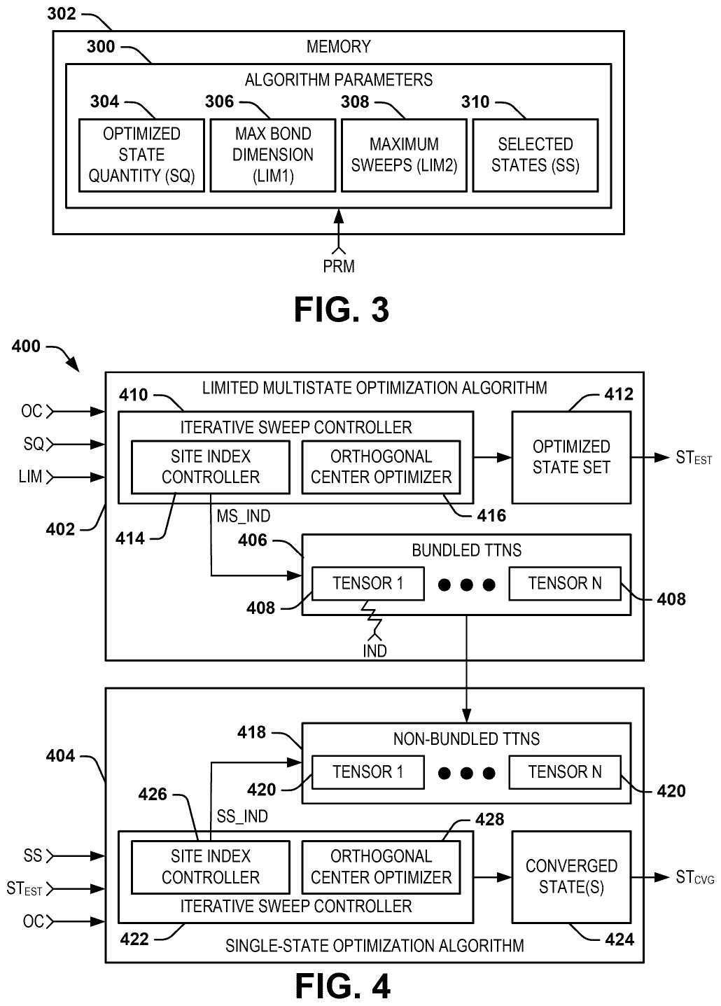

FIG. 3 illustrates an example diagram of algorithm parameters 300 stored in a memory 302. The algorithm parameters 300 are demonstrated as programmable via a signal PRM (e.g., from a user or external data source). The algorithm parameters 300 can correspond to the algorithm parameters 214 in the example of FIG. 2. Therefore, reference is to be made to the example of FIG. 2 in the following description of the example of FIG. 3.

The algorithm parameters 300 include an optimized state quantity (OSQ) 304, a maximum bond dimension (“LIM1”) 306, a maximum number of sweeps (“LIM2”) 308, and a number of selected optimized states (“SS”) 310. The optimized state quantity 304 can correspond to the quantity of eigenstates in the generated bundled TTNS in each iteration of the hybrid eigenstate determination algorithm 202, and thus corresponds to the quantity of estimated extremal eigenstates in the state set, and thus the number of eigenstates that are optimized by the limited multistate optimization algorithm 208 in each iteration of the hybrid eigenstate determination algorithm 202. The optimized state quantity 304 can also determine (e.g., define) a size of the state index. For example, in a sweep of the bundled TTNS during optimization of the state set by the limited multistate optimization algorithm 208, the state index can be sequentially shifted along with the orthogonality center to each tensor of the bundled TTNS to calculate a small eigenproblem for the quantity of estimated extremal eigenstates defined by optimized state quantity 304. Therefore, for a given eigenproblem at the orthogonality center tensor, the limited multistate optimization algorithm 208 provides optimization of only the number of eigenstates defined by the optimized state quantity 304, subject to the orthogonality constraints 212. The optimized state quantity 304 can thus be selected to provide a quantity of eigenstates optimized by the limited multistate optimization algorithm 208 in each iteration to reduce runtime of the limited multistate optimization algorithm 208 relative to a conventional multistate optimization which optimizes the total number of desired eigenstates of a TTNO, but can be balanced with a desired amount of redundancy of the estimated extremal eigenstates to further mitigate state skipping.

The maximum bond dimension 306 and the maximum number of sweeps 308 can correspond to limit parameters that define an amount of convergence provided by the optimization of the estimated extremal eigenstates in each state set in each iteration of the limited multistate optimization algorithm 208. To avoid significantly long runtime operation of the limited multistate optimization algorithm 208, the limited multistate optimization algorithm 208 can implement the limit parameters to provide less than convergence of the estimated extremal eigenstates in each state set. Therefore, upon achieving a given level of convergence, the limit parameters can dictate the transition of the hybrid eigenstate determination algorithm 202 from the limited multistate optimization algorithm 208 to the single-state optimization algorithm 210.

As a first example, after some number of sweep iterations of the bundled TTNS, the limited multistate optimization algorithm 208 can increase the bond dimension of the bundled TTNS to increase accuracy of the estimated eigenstates. The maximum bond dimension 306 can define the optimization limit of the limited multistate optimization algorithm 208 with respect to the bond dimension. As an example, after further sweep iterations of the bundled TTNS, the limited multistate optimization algorithm 208 can compare the change in eigenvalues from the immediately preceding calculation at a lower bond dimension to the present calculation at the current bond dimension. When the optimization of the eigenstates stops changing by less than a predefined tolerance (e.g., which can be a separate algorithm parameter) after increasing bond dimension, the hybrid eigenstate determination algorithm 202 can then switch to the single-state optimization algorithm 210. The maximum bond dimension 306 can thus define a number of times that the bond dimension can be changed by the limited multistate optimization algorithm 208, or can define a maximum magnitude of the bond dimension, to dictate the amount of optimization of the eigenvalues of the state set before the hybrid eigenstate determination algorithm 202 changes to the single-state optimization algorithm 210.

As a second example, the maximum number of sweeps 308 parameter can define a maximum number of iterative sweeps performed by the limited multistate optimization algorithm 208 in each iteration of the hybrid eigenstate determination algorithm 202. The maximum number of sweeps 308 can correspond to a maximum total number of sweeps, such that upon reaching the maximum total number of sweeps defined by the maximum number of sweeps 308, the limited multistate optimization algorithm 208 can increase the bond dimension to provide further optimization of the eigenstates of the state set. Similar to as described above, the limited multistate optimization algorithm 208 can compare the change in eigenvalues from the immediately preceding sweep to the present sweep. When the optimization of the eigenstates after each sweep stops changing by a predefined convergence tolerance (e.g., which can be data included as a separate algorithm parameter), the limited multistate optimization algorithm 208 can increase the bond dimension or the hybrid eigenstate determination algorithm 202 can change to the single-state optimization algorithm 210.

The limit parameters may not necessarily be mutually exclusive. Thus, the limited multistate optimization algorithm 208 can be programmed to implement both or a combination of the maximum bond dimension 306 and the maximum number of sweeps 308. For example, the maximum number of sweeps can correspond to a maximum total number of sweeps for each change in the bond dimension, up to the maximum bond dimension 306. As another example, the hybrid eigenstate determination algorithm 202 can switch from the limited multistate optimization algorithm 208 to the single-state optimization algorithm 210 in response to whichever happens first between achieving the maximum number of sweeps 308 and achieving the maximum bond dimension 306. Accordingly, the limit parameters can define the transition from the limited multistate optimization algorithm 208 to the single-state optimization algorithm 210 in a variety of ways.

The number of selected states 310 can correspond to the quantity of single eigenstates that are selected from the estimated extremal eigenstates in each state set optimized by the limited multistate optimization algorithm 208 to be converged by the single-state optimization algorithm 210 in each iteration of the hybrid eigenstate determination algorithm 202. The quantity of selected eigenstates defined by the number of selected states 310 can be selected as another manner of providing for a more rapid operation of the hybrid eigenstate determination algorithm 202 by having a larger number of selected states 310 versus mitigating state-skipping by having a smaller number of selected states 310.

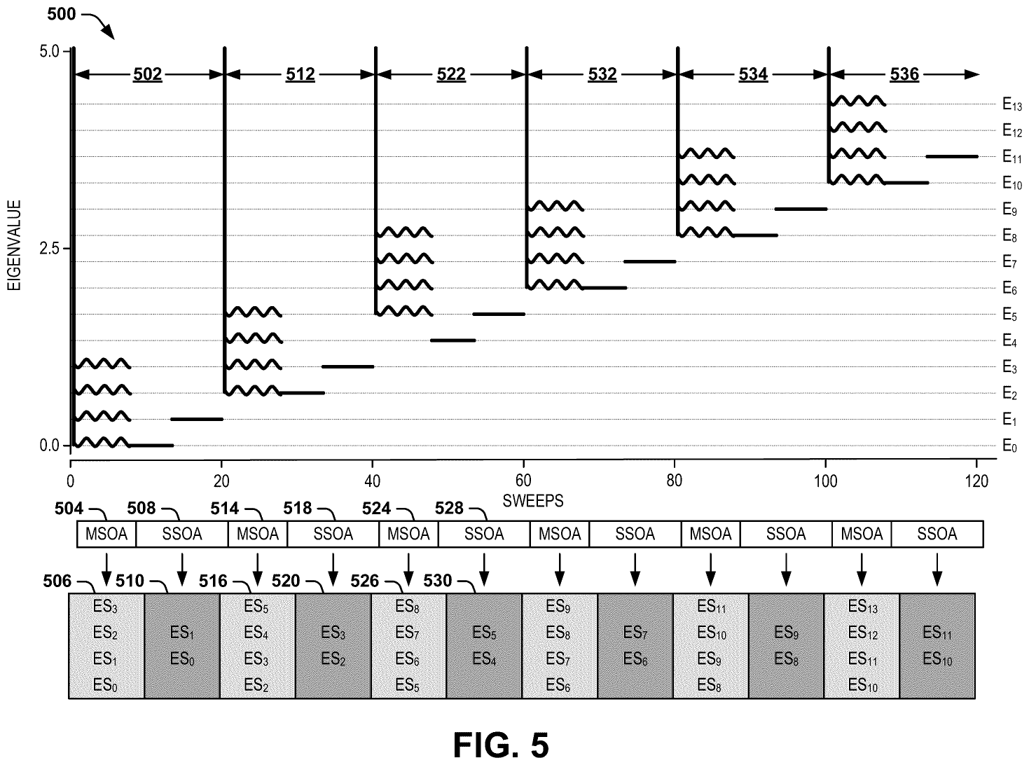

FIG. 4 illustrates an example diagram of a hybrid eigenstate determination algorithm 400. The hybrid eigenstate determination algorithm 400 can correspond to the hybrid eigenstate determination algorithm 202 in the example of FIG. 2. Therefore, reference is to be made to the examples of FIGS. 2 and 3 in the following description of the example of FIG. 4.

The hybrid eigenstate determination algorithm 400 that is configured to determine a desired set of extremal eigenstates of a TTNO (e.g., the TTNO 204). As described above in the examples of FIGS. 1 and 2, the hybrid eigenstate determination algorithm 400 can be configured to operate in a plurality of iterations of implementing both a limited multistate optimization algorithm 402 and a single-state optimization algorithm 404 in a sequence.

In each iteration of the hybrid eigenstate determination algorithm 400, the limited multistate optimization algorithm 402 can generate a bundled TTNS 406 to optimize a state set of eigenstates. In the example of FIG. 4, the bundled TTNS 406 can be generated from the TTNO (e.g., the TTNO 204) and includes a plurality of N of tensors 408 (“TENSOR 1” through “TENSOR N”, hereinafter “bundled tensors 408”). The limited multistate optimization algorithm 402 is demonstrated as including an iterative sweep controller 410 to generate an optimized state set 412 in each iteration of the hybrid eigenstate determination algorithm 400. The limited multistate optimization algorithm 402 is demonstrated as receiving orthogonality constraints OC (e.g., the orthogonality constraints 212 stored in the memory 206) corresponding to converged eigenstates from previous iterations of the hybrid eigenstate determination algorithm 400. The limited multistate optimization algorithm 402 is also demonstrated as receiving algorithm parameters, demonstrated as an optimized state quantity OSQ and limit parameters LIM. The optimized state quantity OSQ can correspond to the optimized state quantity 304 stored in the memory 302, and the limit parameters can correspond to at least one of the maximum bond dimension 306 and the maximum number of sweeps 308 stored in the memory 302.

The iterative sweep controller 410 includes a site index controller 414 and an orthogonal center optimizer 416. The site index controller 414 is configured to perform the sweeps across the bundled tensors 408 by moving the state index and the orthogonality center sequentially along each of the bundled tensors 408. Therefore, at each orthogonality center along the sweep of the bundled tensors 408, the orthogonal center optimizer 416 can provide the calculation of the eigenproblem for each of the extremal eigenstates defined by the orthogonality constraint OC and the optimized state quantity OSC. In the example of FIG. 4, the site index controller 414 is demonstrated as providing a site index MS_IND that can correspond to a reference of the location (i.e., site) of the orthogonality center and the state index at a respective one of the tensors 408 for calculation of the respective eigenproblem of the defined eigenstates. The state index and the orthogonality center is demonstrated in the example of FIG. 4 as a collective index IND on the first bundled tensor 406, such that the site index controller 414 can move the index IND (e.g., the state index and the orthogonality center) to each of the tensors 408 in a sequence from TENSOR 1 to TENSOR N, and back to TENSOR 1 in each iterative sweep of the limited multistate optimization algorithm 402. Upon achieving sufficient optimization of the extremal eigenstates, defined by the limit parameters LIM as described in greater detail above, of the state set defined by the orthogonality constraint OC and the optimized state quantity OSC, the optimized state set 412 can be provided as an output from the limited multistate optimization algorithm 402, demonstrated as the estimated extremal eigenstates ST_{EST}.

In the example of FIG. 4, the single-state optimization algorithm 404 generates an non-bundled TTNS 418 from the bundled TTNS 406 given one of the selected estimated extremal eigenstates ST_{EST} that was optimized by the limited multistate optimization algorithm 402 in the present iteration of the hybrid eigenstate determination algorithm 400. The non-bundled TTNS 418 includes a plurality of N of tensors 420 (“TENSOR 1” through “TENSOR N”, hereinafter “non-bundled tensors 420”). As an example, the hybrid eigenstate determination algorithm 400 can generate the non-bundled TTNS 418 associated with a first one of the estimated extremal eigenstates ST_{EST} of the present iteration. For example, the non-bundled tensors 420 can be substantially similar (e.g., identical) to the bundled tensors 408, such as by copying the bundled tensors 408 to provide the non-bundled tensors 420, with the exception of the orthogonality tensor having the state index.

The single-state optimization algorithm 404 is demonstrated as including an iterative sweep controller 422 to generate at least one converged eigenstate 424 in each iteration of the hybrid eigenstate determination algorithm 400. The single-state optimization algorithm 404 is demonstrated as receiving the orthogonality constraints OC (e.g., the orthogonality constraints 212 stored in the memory 206) corresponding to converged eigenstates from previous iterations of the hybrid eigenstate determination algorithm 400, as well as the estimated extremal eigenstates ST_{EST} generated by the limited multistate optimization algorithm 402 in the same iteration of the hybrid eigenstate determination algorithm 400. The single-state optimization algorithm 404 is also demonstrated as receiving the number of selected states SS algorithm parameter (e.g., stored in the memory 302). Thus, the single-state optimization algorithm 404 can determine the redundancy of the estimated extremal eigenstates ST_{EST}, and can select at least one of the estimated extremal eigenstates ST_{EST} to converge in each iteration of the hybrid eigenstate determination algorithm 400.

Similar to the iterative sweep controller 410, the iterative sweep controller 422 includes a site index controller 426 and an orthogonal center optimizer 428. The site index controller 426 is configured to perform the sweeps across each non-bundled tensor 420 For example, the iterative sweep controller 422 can extract the non-bundled TTNS 418 of the respective one of the estimated extremal eigenstates ST_{EST}, and the site index controller 426 can perform a sequential sweep across the non-bundled tensors 420 by moving an orthogonality center along the non-bundled tensors 420, similar to as described above for the limited multistate optimization algorithm 402. However, none of the non-bundled tensors 408 have a state index IND, and at each orthogonality center along the sweep of the tensors 408, the orthogonal center optimizer 428 can provide the calculation of the eigenproblem for just the selected one of the estimated extremal eigenstates ST_{EST} that was optimized to partial convergence by the limited multistate optimization algorithm 402.

In the example of FIG. 4, the site index controller 426 is demonstrated as providing a site index SS_IND that can correspond to a reference of the location (i.e., site) of the orthogonality center at a respective one of the non-bundled tensors 420 for calculation of the respective eigenproblem of the selected respective one of the eigenstates. The site index controller 426 can move the orthogonality center to each of the non-bundled tensors 420 in a sequence from TENSOR 1 to TENSOR N, and back to TENSOR 1 in each iterative sweep of the single-state optimization algorithm 404. Therefore, the single-state optimization algorithm 404 can provide convergence of the partially optimized selected one of the estimated extremal eigenstates ST_{EST} of the present iteration. Upon achieving convergence of the selected one of the estimated extremal eigenstates ST_{EST}, the converged eigenstate 424 can be provided as an output from the single-state optimization algorithm 404, demonstrated as the converged state ST_{CVG}.

Depending on the algorithm parameter that defines the number of selected states 310, provided to the single-state optimization algorithm 404 as the signal SS, the single-state optimization algorithm 404 can then select another one of the estimated extremal eigenstates ST_{EST} that was optimized by the limited multistate optimization algorithm 402 in the present iteration or previous iterations of the hybrid eigenstate determination algorithm 400 for convergence. The selected additional one of the selected estimated extremal eigenstates ST_{EST} can be subject to the orthogonality constraints OC, and can thus correspond to a next higher or lower eigenvalue in the respective ascending or descending extremal eigenstates of the TTNO 204. The single-state optimization algorithm 404 can then repeat the process described above by generating a new non-bundled TTNS 418 and performing another sweep across the selected additional one of the selected estimated extremal eigenstates ST_{EST} of the tensors 408 in the non-bundled TTNS 418 to provide convergence of the next one of selected eigenstates. Upon achieving convergence of the next selected one of the estimated extremal eigenstates ST_{EST}, the additional converged eigenstate 424 can be provided as another output from the single-state optimization algorithm 404 as the converged state ST_{CVG}. The single-state optimization algorithm 404 can then either select yet another one of the estimated extremal eigenstates ST_{EST} for convergence, or can conclude operation in the present iteration of the hybrid eigenstate determination algorithm 400, based on the number of selected states 310. Upon concluding the present iteration of the hybrid eigenstate determination algorithm 400, the hybrid eigenstate determination algorithm 400 can begin another iteration by switching back to the limited multistate optimization algorithm 402 to optimize a different state set of the eigenstates of the TTNO 204.

FIG. 5 illustrates an example diagram 500 of determining a set of extremal eigenstates, demonstrated in the example of FIG. 5 as having smallest eigenvalues. The diagram 500 can correspond to implementation of the hybrid eigenstate determination algorithm 400, and thus the limited multistate optimization algorithm 402 and the single-state optimization algorithm 404, respectively. In the example of FIG. 5, the processing unit 106 can be configured to determine a quantity of twelve lowest eigenstates for a TTNO. Also in the example of FIG. 5, the optimization state quantity 304 can define that the limited multistate optimization algorithm 402 can generate a bundled TTNS to optimize a quantity of four estimated lowest eigenstates in each iteration of the of the hybrid eigenstate determination algorithm 400 out of the twelve lowest eigenstates to be determined. Additionally, in the example of FIG. 5, the number of selected states 310 can be set such that the single-state optimization algorithm 404 can select and optimize two of the four estimated lowest eigenstates generated by the limited multistate optimization algorithm 402 in each iteration.

In a first iteration 502, the limited multistate optimization algorithm 402 generates an initial bundled TTNS representing four eigenstates that can each have a high eigenvalue. After at least one sweep, the eigenvalue of the four estimated eigenstates decreases significantly, and eventually settles to four estimated lowest eigenstates. The estimated lowest eigenvalue is demonstrated as E₀, and the estimated next lowest eigenvalues E₁, E₂, and E₃ each have a higher eigenvalue with respect to each other. The four estimated lowest eigenstates associated with these values are demonstrated as ES₀, ES₁, ES₂, and ES₃eigenstate. After a plurality of sweeps (e.g., approximately seven sweeps in the example of FIG. 5), and thus further optimization of the bundled TTNS, the estimated lowest eigenstates ES₀, ES₁, ES₂, and ES₃ can be optimized to partial convergence. The operation of the limited multistate optimization algorithm 402 (“MSOA”) in the first iteration 502 is demonstrated at 504. Upon achieving an optimization limit based on at least one of the limit parameters (e.g., maximum bond dimension 306 or maximum number of sweeps 308), the limited multistate optimization algorithm 504 concludes in the first iteration 502. Therefore, the hybrid eigenstate determination algorithm 400 stores the estimated lowest eigenstates ES₀, ES₁, ES₂, and ES₃ in the memory 206 as the estimated extremal eigenstates 218, demonstrated at 506, and switches from the limited multistate optimization algorithm 402 to the single-state optimization algorithm 404.

In the first iteration 502, the single-state optimization algorithm 404 selects the lowest eigenstate of the estimated lowest eigenstates determined by the limited multistate optimization algorithm 504 in the first iteration 502. Thus, the single-state optimization algorithm 404 selects the estimated eigenstate ES₀. For example, the processing unit 106 can be configured to generate a tensor network state (non-bundled) associated with the estimated eigenstate ES₀ and can further optimize the estimated eigenstate ES₀ to convergence by sweeping across and calculating the eigenproblem at each (non-bundled) tensor of the respective tensor network state(s) of the respective estimated eigenstate ES_{G}. The single-state optimization algorithm 404 thus further optimizes the estimated eigenstate ES0 to convergence (e.g., after approximately six or seven sweeps and one or two bond dimension increases). As described above, the number of selected states 310 can be set to two. Therefore, after optimizing the estimated eigenstate ES0 to convergence, the single-state optimization algorithm 404 can further optimize the estimated eigenstate ES₁ to convergence (e.g., after approximately six or seven sweeps and one or two bond dimension increases), such as based on the orthogonality constraint of the estimated eigenstate ES₀. The operation of the single-state optimization algorithm 404 (“SSOA”) in the first iteration 502 is demonstrated at 508. Upon optimizing the two lowest eigenstates ES₀ and ES₁, the hybrid eigenstate determination algorithm 400 stores the converged lowest eigenstates ES₀ and ES₁ in the memory 206 as the orthogonality constraints 212, demonstrated at 510.

In a second iteration 512, the limited multistate optimization algorithm 402 generates another initial bundled TTNS representing four eigenstates. However, the next four eigenstates are subject to the orthogonality constraints 212 to ensure that the converged lowest eigenstates ES₀ and ES₁ are not optimized by the limited multistate optimization algorithm 402. After at least one sweep, the eigenvalues of the four estimated eigenstates decreases significantly, and eventually settles to four estimated lowest eigenstates that are orthogonal with respect to each other, and are also orthogonal with respect to the converged lowest eigenstates ES₀ and ES₁, after a plurality of sweeps. Thus, the four estimated lowest eigenstates are demonstrated as a state set that includes the lowest eigenstates ES₂, ES₃, ES₄, and ES₅, with each of the lowest eigenvalues E₂, E₃, E₄, and E₅ being consecutively higher eigenvalues.

Based on the orthogonality constraints 212 of the converged lowest eigenstates ES₀ and ES₁ from the first iteration 502, the state set in the second iteration 512 is different from the state set in the first iteration 502. However, the state set in the second iteration 512 includes some overlap with the lowest eigenstates of the state set in the first iteration 502, thereby providing redundancy with respect to the state set in the first iteration 502 to ensure that state-skipping is mitigated. After a plurality of sweeps (e.g., approximately seven sweeps in the example of FIG. 5), and thus further optimization of the bundled TTNS, the estimated lowest eigenstates ES₂, ES₃, ES₄, and ES₅ can be optimized to partial convergence. The operation of the limited multistate optimization algorithm 402 (“MSOA”) in the second iteration 512 is demonstrated at 514. Upon achieving the optimization limit defined by the limit parameter(s), the limited multistate optimization algorithm 514 concludes in the second iteration 512. Therefore, the hybrid eigenstate determination algorithm 400 stores the estimated lowest eigenstates ES₂, ES₃, ES₄, and ES₅ in the memory 206 as the estimated extremal eigenstates 218, demonstrated at 516, and switches from the limited multistate optimization algorithm 402 to the single-state optimization algorithm 404.

The estimated lowest eigenvalue E₂, associated with the respective eigenstate ES₂ can correspond to a next higher eigenvalue relative to the converged lowest eigenvalue E₁. For example, the single-state optimization algorithm 404 can access the highest converged lowest eigenstate in the memory 206 (e.g., the orthogonality constraints 212) to determine if the lowest of the estimated lowest eigenvalues E₂, E₃, E₄, and E₅ is a next consecutive higher eigenvalue relative to the converged lowest eigenstate ES₁. Therefore, the single-state optimization algorithm 404 can identify that the estimated lowest eigenstate ES₂ is the next higher eigenvalue relative to the highest converged lowest eigenstate ES₁ to determine that the estimated lowest eigenstate ES₂ is the correct lowest eigenstate for optimization in the second iteration 512.

Thus, in the second iteration 512, the single-state optimization algorithm 404 selects the lowest eigenstate of the estimated lowest eigenstates determined by the limited multistate optimization algorithm 402 in the second iteration 512. Thus, the single-state optimization algorithm 404 selects the estimated eigenstate ES₂. The single-state optimization algorithm 404 thus further optimizes the estimated eigenstate ES₂ to convergence (e.g., after approximately six or seven sweeps and one or two bond dimension increases). Because the number of selected states 310 is two in the example of FIG. 5, after optimizing the estimated eigenstate ES₂ to convergence, the single-state optimization algorithm 404 can further optimize the estimated eigenstate ES₃ to convergence (e.g., after approximately six or seven sweeps and one or two bond dimension increases), such as based on the orthogonality constraints of the previously estimated eigenstates ES₀, ES₁, ES₂. The operation of the single-state optimization algorithm 404 (“SSOA”) in the second iteration 512 is demonstrated at 518. Upon optimizing the two lowest eigenstates ES₂ and ES₃, the hybrid eigenstate determination algorithm 400 stores the converged lowest eigenstates ES₂ and ES₃ in the memory 206 as further orthogonality constraints 212, demonstrated at 520.

In a third iteration 522, the limited multistate optimization algorithm 402 generates another initial bundled TTNS representing four eigenstates. However, the next four eigenstates are selected subject to the orthogonality constraints 212 from the first two iterations 502 and 512 to ensure that the converged lowest eigenstates ES₀, ES₁, ES₂, and ES₃ are not optimized by the limited multistate optimization algorithm 402. After at least one sweep, the eigenvalues of the four estimated eigenstates decrease significantly, and eventually settles to four estimated lowest eigenstates that are orthogonal with respect to each other, and are also orthogonal with the converged lowest eigenstates ES₀, ES₁, ES₂, and ES₃, after a plurality of sweeps. However, the four estimated lowest eigenstates in the third iteration 522 are demonstrated as a state set that includes the estimated lowest eigenstates ES₅, ES₆, ES₇, and ES₈, with each of the estimated lowest eigenvalues E₅, E₆, E₇, and E₅ being consecutively higher eigenvalues. Thus, in the example of the third iteration 522, the state set that is optimized by the limited multistate optimization algorithm 402 skipped the estimated lowest eigenstate ES₄, such as based on the selected arbitrary eigenstates having insufficient overlap with the previously converged lowest eigenstate ES₃.

After a plurality of sweeps (e.g., approximately seven sweeps in the example of FIG. 5), and thus further optimization of the bundled TTNS, the four estimated lowest eigenstates ES₅, ES₆, ES₇, and ES₈ can be optimized to partial convergence. The operation of the limited multistate optimization algorithm 402 (“MSOA”) in the third iteration 522 is demonstrated at 524. Upon achieving the optimization limit defined by the limit parameter(s), the limited multistate optimization algorithm 514 concludes in the third iteration 522. Therefore, the hybrid eigenstate determination algorithm 400 stores the estimated lowest eigenstates ES₅, ES₆, ES₇, and ES₈ in the memory 206 as the estimated extremal eigenstates 218, demonstrated at 526, and switches from the limited multistate optimization algorithm 402 to the single-state optimization algorithm 404.

As an example, in each iteration, the processing unit 106 can access the estimated lowest eigenvalues (e.g., the eigenvalues associated with the estimated lowest eigenstates 218) and the converged lowest eigenstates (e.g., the orthogonality constraints 212) from the previous iteration saved in the memory 108 for redundancy, and thus to determine proper selection of the estimated lowest eigenstate(s) by the single-state optimization algorithm 404 in the present iteration. In the example of the third iteration 522, the processing unit 106 can identify that the lowest of the estimated eigenvalues in the third iteration (e.g., the estimated lowest eigenvalue E₅) is not the next higher eigenvalue relative to the converged lowest eigenvalue E₃. Therefore, the processing unit 106 can identify that the lowest eigenstate ES₄ was skipped by the limited multistate optimization algorithm 402. As a result, the processing unit 106 can access the estimated lowest eigenstate ES₄ from the memory 108, having previously determined the estimated lowest eigenvalue E₄ in the second iteration 512. The single-state optimization algorithm 404 can thus select the estimated lowest eigenstate ES₄ for convergence, despite the estimated lowest eigenstate ES₄ being absent from the state set determined by the limited multistate optimization algorithm 402 in the present iteration.

Because the number of selected states 310 is set to two in the example of FIG. 5, the single-state optimization algorithm 404 subsequently selects the next estimated lowest eigenstate ES₅ (e.g., from the determination by the limited multistate optimization algorithm 402 in the third iteration 522) for convergence. The single-state optimization algorithm 404 thus further optimizes the estimated eigenstate ES₅ to convergence (e.g., after approximately six or seven sweeps and one or two bond dimension increases). The operation of the single-state optimization algorithm 404 (“SSOA”) in the third iteration 522 is demonstrated at 528. Upon optimizing the two lowest eigenstates ES₄ and ES₅, the hybrid eigenstate determination algorithm 400 stores the converged lowest eigenstates ES₄ and ES₅ in the memory 206 as further orthogonality constraints 212, demonstrated at 530.

The hybrid eigenstate determination algorithm 400 continues to operate as described above in each of a subsequent fourth iteration 532, a fifth iteration 534, and a sixth iteration 536 until all of the lowest eigenstates associated with the bundled TTNS are consecutively determined. Thus, the converged lowest eigenstates ES₆ and ES₇ are determined in the fourth iteration 532, the converged lowest eigenstates ES₈ and ES₉ are determined in the fifth iteration 534, and the converged lowest eigenstates ES₁₀ and ES₁₁ are determined in the sixth iteration 536. Accordingly, by implementing the hybrid eigenstate determination algorithm 400 as including both the limited multistate optimization algorithm 402 and the single-state optimization algorithm 404 in each of the iterations 502, 512, 522, 532, 534, and 536, the desired lowest eigenstates of the TTNO can be determined rapidly and in ascending order while minimizing the skipping of any of the lowest eigenstates.

The example of FIG. 5 demonstrates one example of implementation of the hybrid eigenstate determination algorithm 400. Specifically, in the example of FIG. 5, the hybrid eigenstate determination algorithm 400 is programmed to determine a quantity of twelve lowest eigenstates of the TTNO by implementing six iterations in which the limited multistate optimization algorithm 402 determines four estimated lowest eigenstates (e.g., as defined by the optimized state quantity 304) and in which the single-state optimization algorithm 404 further optimizes two of the estimated lowest eigenstates (based on the number of selected states 310) to convergence. However, other examples are possible.

For example, the optimized state quantity 304 can be selected such that the hybrid eigenstate determination algorithm 400 can determine more or fewer lowest eigenstates of the TTNO. As another example, the limited multistate optimization algorithm 402 can determine more estimated lowest eigenstates to mitigate state-skipping and provide more redundancy, or can determine fewer estimated lowest eigenstates to operate at greater speed and less computational cost. As another example, the number of selected states 310 can be different from the two demonstrated in the example of FIG. 5. Therefore, the single-state optimization algorithm 404 can further optimize a single estimated lowest eigenstate for greater accuracy in determination of the lowest eigenstates, or can further optimize more than two estimated lowest eigenstates to provide for greater operational speed. As yet another example, while the hybrid eigenstate determination algorithm 400 is demonstrated in the example of FIG. 5 as determining the lowest eigenstates as the extremal eigenstates, the hybrid eigenstate determination algorithm 400 could instead determine the highest eigenstates as the extremal eigenstates. Therefore, the hybrid eigenstate determination algorithm 400 can be operated in any of a variety of ways.

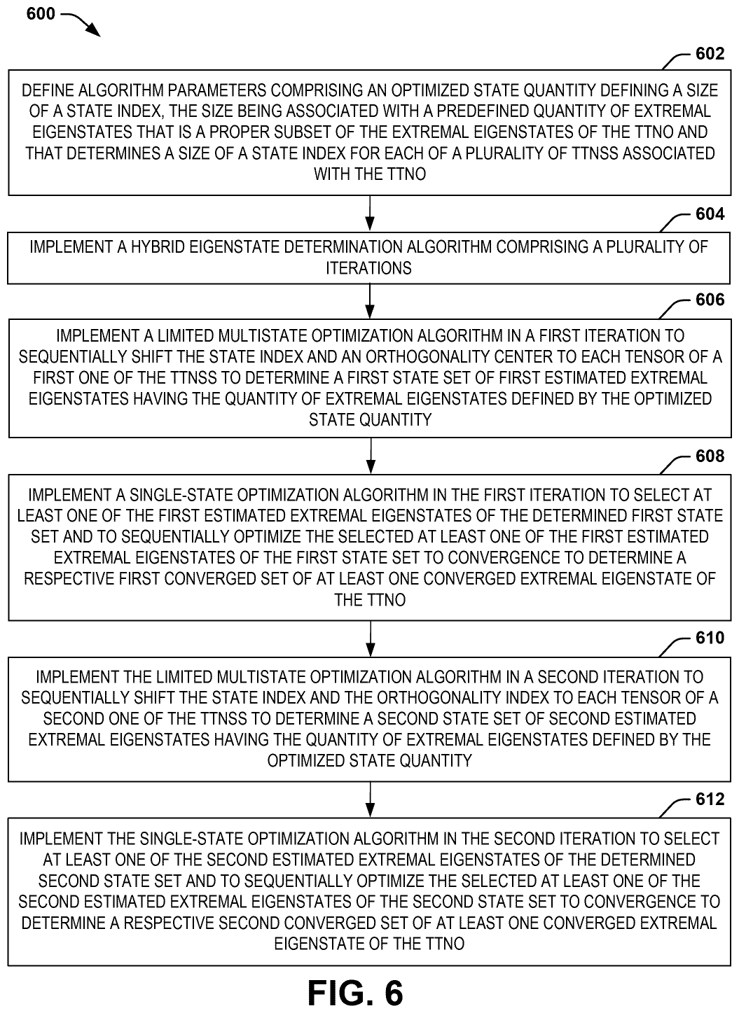

In view of the foregoing structural and functional features described above, a methodology in accordance with various aspects of the disclosure will be better appreciated with reference to FIG. 6. It is to be understood and appreciated that the method of FIG. 6 is not limited by the illustrated order, as some aspects could, in accordance with the present disclosure, occur in different orders and/or concurrently with other aspects from that shown and described herein. Moreover, not all illustrated features may be required to implement a methodology in accordance with an aspect of the present examples.

FIG. 6 illustrates an example of a method 600 for determining a plurality of extremal eigenstates of a tree tensor network operator (e.g., the TTNO 102). At 602, algorithm parameters are defined comprising an optimized state quantity (e.g., optimized state quantity 304) that defines a size of a state index for each of a plurality of bundled TTNSs (e.g., the bundled TTNS 406) associated with the TTNO, the size being associated with a predefined quantity of extremal eigenstates that is a proper subset of the extremal eigenstates of the TTNO. At 604, a hybrid eigenstate determination algorithm (e.g., the hybrid eigenstate determination algorithm 110) comprising a plurality of iterations is implemented. Two iterations are demonstrated in the example of FIG. 6.

At 606, a limited multistate optimization algorithm (e.g., the limited multistate optimization algorithm 208) is implemented in a first iteration to sequentially shift the state index and an orthogonality center to each tensor of a first one of the bundled TTNSs to determine a first state set comprising first estimated extremal eigenstates having the predefined quantity of extremal eigenstates defined by the optimized state quantity. At 610, a single-state optimization algorithm (e.g., the single-state optimization algorithm 210) is implemented in the first iteration to select at least one of the first estimated extremal eigenstates of the determined first state set and to sequentially optimize the selected at least one of the first estimated extremal eigenstates of the first state set to convergence to determine a respective first converged set of at least one converged extremal eigenstate of the TTNO. At 612, the limited multistate optimization algorithm is implemented in a second iteration to sequentially shift the state index and the orthogonality center to each tensor of a second one of the bundled TTNSs to determine a second state set comprising second estimated extremal eigenstates having the predefined quantity of extremal eigenstates defined by the optimized state quantity. At 614, the single-state optimization algorithm is implemented in the second iteration to select at least one of the second estimated extremal eigenstates of the determined second state set and to sequentially optimize the selected at least one of the second estimated extremal eigenstates of the second state set to convergence to determine a respective second converged set of at least one converged extremal eigenstate of the TTNO.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A system comprising:
a non-transitory memory that stores machine-readable instructions; and
a processing unit that accesses the memory and executes the machine-readable instructions, the machine-readable instructions comprising a hybrid eigenstate determination algorithm, the hybrid eigenstate determination algorithm comprising:
a limited multistate optimization algorithm configured to determine a state set comprising estimated extremal eigenstates of a bundled tree tensor network state (TTNS) based on predefined algorithm parameters and orthogonality constraints, the bundled TTNS being associated with a tree tensor network operator (TTNO) to be determined; and
a single-state optimization algorithm configured to select at least one estimated extremal eigenstate of the determined state set and to sequentially optimize the selected at least one estimated extremal eigenstate of the state set to convergence to determine a respective at least one of the extremal eigenstates of the TTNO.

2. The system of claim 1, wherein the predefined algorithm parameters comprise an optimized state quantity that defines a quantity of the estimated extremal eigenstates in the state set that is a proper subset of the quantity of extremal eigenstates of the TTNO and that determines a size of a state index, the state index being sequentially shifted along with an orthogonality center to each of a plurality of tensors of the bundled TTNS during a sweep of the bundled TTNS to optimize the quantity of the estimated extremal eigenstates of the extremal eigenstates of the TTNO associated with the bundled TTNS as defined by the optimized state quantity.

3. The system of claim 1, wherein the hybrid eigenstate determination algorithm is configured to operate in a plurality of iterations comprising the limited multistate optimization algorithm followed by the single-state optimization algorithm, such that the limited multistate optimization algorithm is configured to determine the state set in each of the iterations, the state set being different in each of the iterations, and such that the single-state optimization algorithm is configured to select the at least one estimated extremal eigenstate of the state set associated with the respective iteration and to sequentially optimize the selected at least one estimated extremal eigenstate of the state set associated with the respective one of the iterations to convergence to determine the at least one of the extremal eigenstates in each of the iterations to determine the extremal eigenstates of the TTNO.

4. The system of claim 3, wherein at least one estimated extremal eigenstate in a given iteration after a first iteration is nominally common to a state set associated with a preceding sequential iteration, wherein the processing unit is configured to store the estimated extremal eigenstates of each state set in each of the iterations in the memory, and to store the determined at least one of the extremal eigenstates in each of the iterations in the memory.

5. The system of claim 4, wherein the processing unit is configured to compare the estimated extremal eigenstates of a state set associated with a given one of the iterations with the estimated extremal eigenstates of a state set associated with a preceding sequential iteration to determine redundancy.

6. The system of claim 4, wherein the processing unit is configured to provide the determined at least one of the extremal eigenstates of a given one of the iterations as an orthogonality constraint to the limited multistate optimization algorithm, such that the limited multistate optimization algorithm is configured to determine the estimated extremal eigenstates of a state set associated with a next one of the iterations as having higher or lower eigenstates relative to the at least one of the extremal eigenstates of the given one of the iterations.

7. The system of claim 4, wherein the processing unit is configured to determine if an estimated extremal eigenstate of a state set of a given one of the iterations is an estimated next higher or lower eigenstate relative to the determined at least one of the extremal eigenstates of a preceding sequential iteration, and in response to determining that the estimated extremal eigenstate of the state set of the given one of the iterations is not the estimated next higher or lower eigenstate of the preceding sequential iteration, is configured to access an estimated next higher or lower eigenstate of a state set of the preceding sequential iteration from the memory and to optimize the accessed estimated next higher or lower eigenstate to convergence via the single-state optimization algorithm in the given one of the iterations.

8. The system of claim 1, wherein the predefined algorithm parameters comprise a maximum bond dimension of the tensors of the bundled TTNS during operation of the limited multistate optimization algorithm in each iteration of the hybrid eigenstate determination algorithm.

9. The system of claim 1, wherein the predefined algorithm parameters comprise a maximum number of sweeps during operation of the limited multistate optimization algorithm in each iteration of the hybrid eigenstate determination algorithm.

10. The system of claim 1, wherein the predefined algorithm parameters comprise a quantity of the estimated extremal eigenstates of each state set that is selected to be optimized to convergence by the single-state optimization algorithm in each iteration of the hybrid eigenstate determination algorithm.

11. A method for determining a plurality of extremal eigenstates of a tree tensor network operator (TTNO), the method comprising:
defining algorithm parameters comprising an optimized state quantity that defines a quantity of extremal eigenstates that is a proper subset of the extremal eigenstates of the TTNO and that determines a size of a state index for each of a plurality of bundled tree tensor network states (TTNSs) associated with the TTNO; and
implementing a hybrid eigenstate determination algorithm comprising a plurality of iterations, wherein implementing the hybrid eigenstate determination algorithm comprises:
implementing a limited multistate optimization algorithm in a first iteration to sequentially shift the state index and an orthogonality center to each tensor of a first one of the TTNSs to determine a first state set comprising first estimated extremal eigenstates having the quantity of extremal eigenstates defined by the optimized state quantity;
implementing a single-state optimization algorithm in the first iteration to select at least one of the first estimated extremal eigenstates of the determined first state set and to sequentially optimize the selected at least one of the first estimated extremal eigenstates of the first state set to convergence to determine a respective first converged set of at least one converged extremal eigenstate of the TTNO;
implementing the limited multistate optimization algorithm in a second iteration to sequentially shift the state index and the orthogonality index to each tensor of a second one of the TTNSs to determine a second state set comprising second estimated extremal eigenstates having the quantity of extremal eigenstates defined by the optimized state quantity;
implementing the single-state optimization algorithm in the second iteration to select at least one of the second estimated extremal eigenstates of the determined second state set and to sequentially optimize the selected at least one of the second estimated extremal eigenstates of the second state set to convergence to determine a respective second converged set of at least one converged extremal eigenstate of the TTNO.

12. The method of claim 11, wherein at least one of the second estimated extremal eigenstates in the second bundled TTNS is redundant with at least one of the first estimated extremal eigenstates in the first bundled TTNS, the method further comprising:
storing the first and second estimated extremal eigenstates in a memory; and
storing the determined first and second converged sets in the memory.

13. The method of claim 12, further comprising providing the determined first converged set as an orthogonality constraint to the limited multistate optimization algorithm, wherein implementing the limited multistate optimization algorithm in the second iteration comprises determining the second estimated extremal eigenstates of the second state set as having higher or lower eigenstates relative to the first converged set.

14. The method of claim 12, further comprising:
determining if a most extreme of the second estimated extremal eigenstates is an estimated next higher or lower eigenstate relative to the determined first converged set;
in response to determining that the most extreme of the second estimated extremal eigenstates is not the estimated next higher or lower eigenstate relative to the determined first converged set, accessing an estimated next higher or lower eigenstate of the first state set from the memory; and
optimizing the accessed estimated next higher or lower eigenstate to convergence via the single-state optimization algorithm in the second iteration.

15. The method of claim 11, wherein the predefined algorithm parameters comprise at least one of a maximum bond dimension of the tensors of the bundled TTNS and a maximum number of sweeps during operation of the limited multistate optimization algorithm in each iteration of the hybrid eigenstate determination algorithm.

16. A non-transitory computer readable medium comprising machine-readable instructions, the machine-readable instructions being executed to implement a hybrid eigenstate determination algorithm in each of a plurality of iterations, the hybrid eigenstate determination algorithm being configured to:
generate a bundled tree tensor network state (TTNS) associated with a tree tensor network operator (TTNO) in each of the iterations;
implement a limited multistate optimization algorithm configured to determine a state set in each of the iterations, the state set being different in each of the iterations and comprising estimated extremal eigenstates of the bundled TTNS based on predefined algorithm parameters; and
implement a single-state optimization algorithm configured to select at least one estimated extremal eigenstate of the determined state set associated with the respective one of the iterations and to sequentially optimize the selected at least one estimated extremal eigenstate of the state set associated with the respective one of the iterations to convergence to determine a respective at least one of the extremal eigenstates of the bundled TTNS in each of the iterations to determine the extremal eigenstates of the TTNO.

17. The medium of claim 16, wherein the predefined algorithm parameters comprise an optimized state quantity that defines a quantity of the estimated extremal eigenstates in the state set that is a proper subset of the quantity of extremal eigenstates of the TTNO and that determines a size of a state index, the state index being sequentially shifted along with an orthogonality center to each of a plurality of tensors of the bundled TTNS during a sweep of the bundled TTNS to optimize the quantity of the estimated extremal eigenstates of the extremal eigenstates of the TTNO associated with the bundled TTNS in the limited multistate optimization algorithm in each of the iterations as defined by the optimized state quantity.

18. The medium of claim 16, wherein the limited multistate optimization algorithm is configured to provide the determined at least one of the extremal eigenstates of a given one of the iterations as an orthogonality constraint to the limited multistate optimization algorithm, such that the limited multistate optimization algorithm is configured to determine the estimated extremal eigenstates of a state set associated with a next one of the iterations as having higher or lower eigenstates relative to the at least one of the extremal eigenstates of the given one of the iterations.

19. The medium of claim 16, wherein the limited multistate optimization algorithm is configured to determine if an estimated extremal eigenstate of a state set of a given one of the iterations is an estimated next higher or lower eigenstate relative to the determined at least one of the extremal eigenstates of a preceding one of the iterations, and in response to determining that the estimated extremal eigenstate of the state set of the given one of the iterations is not the estimated next higher or lower eigenstate of the immediately preceding one of the iterations, is configured to access an estimated next higher or lower eigenstate of a state set of the immediately preceding one of the iterations from the memory and to optimize the accessed estimated next higher or lower eigenstate to convergence via the single-state optimization algorithm in the given one of the iterations.

20. The medium of claim 16, wherein the predefined algorithm parameters comprise at least one of a maximum bond dimension of the tensors of the bundled TTNS and a maximum number of sweeps during operation of the limited multistate optimization algorithm in each iteration of the hybrid eigenstate determination algorithm.
